(19) United States
(12) Patent Application Publication
(10) Pub. No.: US 2008/0245200 A1
(43) Pub. Date: Oct. 9, 2008

(54) Electric Saw with Operator Protection System

(75) Inventor: Clyde Mark Campbell, Balmoral (AU)

Correspondence Address: PEARNE & GORDON LLP, 1801 EAST 9TH STREET, SUITE 1200, CLEVELAND, OH, 44114-3108, US

(73) Assignee: BLADESTOP PTY LIMITED, SILVERWATER NSW 2128 (AU)

(21) Appl. No.: 11/996,059

(22) PCT Filed: Jul. 18, 2006
(86) PCT No.: PCT/AU2006/001010

§ 371 Date: Jun. 10, 2008

(30) Foreign Application Priority Data
Jul. 18, 2005 (AU) 2005903786
Apr. 28, 2006 (AU) 2006902226

(51) Int. Cl. B27B 13/14; B23Q 11/00; F16P 3/12

(52) U.S. Cl. 83/13; 83/61; 83/73; 83/74; 83/701

(57) ABSTRACT

There is described a control system for an electrically powered saw of the type incorporating a table through which the blade of the saw passes. The control system comprises a clamping mechanism (16, 16a) having clamping members (18, 20) counter-rotatable relative to one another to clamp the blade (4) in use to stop travel of the blade in event of an operator coming into electrical contact with the blade during use of the saw. The control system monitors for an electrical signal conducted between the operator and the blade or the blade and the operator upon contact of the operator with the blade.

### FIELD OF THE INVENTION

The present invention relates to an electric saw adapted to protect an operator from the blade of the saw, and a control system for detecting contact of the operator with the blade in use and stopping travel of the blade. The invention finds particular application to saws commonly used in the meat processing industry.

### BACKGROUND OF THE INVENTION

Band saws are commonly lined to cut carcasses and meat sections in the red meat industry as part of the meat processing stage. When using a band saw, the operator physically holds the carcass or meat section either side of the band saw blade and drives the meat into the blade to effect the cutting operation. This inherently places the operator at risk of contacting the blade in the event of slipping or for example as a result of inattention.

While guards can be used to cover the blade, a region of the blade remains exposed to the operator. For larger cuts of meat and carcasses, a significant section of the blade must remain exposed. Contact with the blade can result in serious injury including loss of digits and worse. Once an operator recognizes they have come into contact with the blade and takes corrective action, there is nevertheless a time delay involved in which significant injury can be sustained from the blade. Similarly, even if an emergency stop button is activated, the motor may still undergo several rotations before being brought to a stop with continued resulting travel of the blade.

Injuries to operators can be debilitating for the operator, distressing to all involved, and costly to employers in terms of downtime, loss of productivity and associated rehabilitation of the employee.

### SUMMARY OF THE INVENTION

It is an aim of the present invention to ameliorate one or more problems of the prior art or to at least provide a useful alternative.

In an aspect of the present invention there is provided an operator protection system for protecting an operator of an electrically powered saw from the blade of the saw during a cutting operation, the saw being of the type including a cutting table through which the blade passes, and the protection system comprising:

clamping means for clamping the blade to stop travel of the blade;

control system means conductively connected to the blade and adapted to monitor for conduction of an electrical signal between the operator and the blade in event of electrical contact of the operator with the blade; and

actuator means operable by the control system means to operate the clamping means to clamp the blade upon detection of the conduction of the electrical signal by the control system means.

In another aspect of the present invention there is provided a clamping mechanism for being fitted to an electrically powered saw of the type incorporating a cutting table through which the blade of the saw passes and to stop travel of the blade in event of an operator coming into contact with the blade during a cutting operation, the clamping mechanism comprising:

clamping means arranged for clamping the blade to stop the travel of the blade; and

actuator means operable by control system means of the saw to operate the clamping means to clamp the blade.

Typically, the clamping means will be adapted to break or shear the blade during the clamping of the blade.

Preferably, the clamping means will comprise a pair of spaced apart clamping members at least one of which is rotatable about its axis of rotation into contact with the blade, the blade passing between the clamping members.

Preferably, each clamping member will be rotatable in an opposite direction to the other of the clamping members to effect the clamping of the blade. Typically, the rotation of the one clamping member will drive rotation of the other of the clamping members. Most preferably, the clamping members will be provided with intermeshing teeth for driving the rotation of the clamping members. In an alternative embodiment the clamping members are coupled together by a coupling element for driving the rotation of the other clamp member with the one clamp member.

Preferably, the actuator means of an embodiment of the invention will comprise:

drive means for driving the rotation of at least the one clamping member about its axis of rotation; and

restraining means for restraining the rotation of the one clamping member and being adapted to permit the drive means to rotate the one clamping member with operation of the actuator means by the control system means.

Preferably, the drive means will comprise spring means arranged for priming the at least one clamping member to rotate about its axis.

Preferably, the actuator means further comprises a solenoid and the restraining means comprises a latch operable by the solenoid to permit the drive means to effect the rotation of the clamping member(s).

In another aspect of the present invention there is provided a clamping mechanism suitable for being fitted to an electrically powered saw of the type incorporating a cutting table through which the blade of the saw passes and to stop travel of the blade in event of an operator coming into contact with the blade during a cutting operation, the clamping mechanism comprising:

a pair of clamping members arranged in a side by side relationship for reception of the blade therebetween and rotatable in opposite directions into contact with the blade to clamp the blade to stop travel of the blade, the clamping members being adapted to co-operate to break or shear the blade during clamping of the blade; and

actuator means for driving rotation of the clamping members to clamp the blade.

Typically, the control system means will comprise a touch sensing circuit for sensing electrical contact of the operator with the blade during the cutting operation, and an emergency stop circuit for triggering the actuator means to operate the clamping means to clamp the blade and which is responsive to the touch sensing circuit.

Hence, in another aspect of the present invention there is provided a control system for protecting an operator from the blade of an electrically powered saw during a cutting operation utilizing the saw, the saw being of the type comprising a cutting table through which the blade passes, and the control system comprises:

a touch sensing circuit for sensing conduction of an electrical signal between the operator and the blade in event of electrical contact of the operator with the blade;

an emergency stop circuit for triggering operation of clamping means to clamp the blade to stop travel of the blade, the emergency stop circuit being responsive to the touch sensing circuit, and the touch sensing circuit is configured for being conductively connected with the blade.

Preferably, the touch sensing circuit will be adapted to compensate for electrical resistance of the operator for the sensing of the conduction of the electrical signal.

Preferably, the saw will comprise a saw motor for driving the blade and the control system will further comprise an operator sensing circuit for sensing presence of the operator and allowing operation of the saw motor only when the presence of the operator is sensed.

The conduction of the electrical signal may be from the operator to the blade of the saw or from the saw to the operator. In the first instance, a voltage may be applied to the operator for generation of the signal. In the later instance, a voltage may be applied to the saw or directly to the blade for generation of the signal. Accordingly, an embodiment of the present invention may further incorporate voltage applying means for applying the voltage.

Any suitable voltage applying means may be utilized for applying a voltage to the operator. For example, the voltage applying means may comprise spaced apart conductive surfaces on which the operator stands during use with one foot on each to induce for flow of electric current through the operator from one leg to the other, or an arm strap adapted to be worn by the operator, or a combination of both.

Preferably, the control system will further comprise a saw enable circuit for monitoring operational status of the control system and rendering the saw inoperable if the saw enable circuit fails to sense correct operational status of the control system.

In still another aspect of the present invention there is provided a method for protecting an operator of an electrically powered saw from the blade of the saw during a cutting operation, the saw being of the type incorporating a culling table through which the blade passes, the method comprising:

providing clamping means for clamping the blade to stop travel of the blade;

insulating the operator against electrical contact with the blade, the band saw having control system means for monitoring for conduction of an electrical signal between the control system means and the blade in event of the operator coming into electrical contact with the blade; and

monitoring for conduction of the electrical signal using the control system means, the clamping means being operable to clamp the blade upon detection of the conduction of the electrical signal by the control system means and the control system means being conductively connected to the blade.

There is also provided an electrically powered saw incorporating an operator protection system embodied by the present invention.

The saw may, for instance, be selected from the group consisting of band saws, table mounted circular saws and mitre saws. Typically, the saw will be a band saw.

As will be appreciated, the use of an embodiment of a saw of the invention may save operators from amputations or significantly lessen the seriousness of injury resulting from contact with the blade of the saw. While saws of the invention find particular application to the red meal processing industry, it will be understood that embodiments of the invention have broader application and the invention is not limited thereto.

Any publications mentioned in this specification are herein incorporated by reference. Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers, integers or steps.

The features and advantages of methods of the present invention will become further apparent from the following detailed description of preferred embodiments and the accompanying figures.

### BRIEF DESCRIPTION OF THE ACCOMPANYING FIGURES

FIG. 1 shows a front schematic view of a band saw embodied by the present invention;

FIG. 2 shows a plan schematic view of the band saw of FIG. 1;

FIG. 3 shows a front perspective view of a clamping mechanism of the band saw of FIG. 1;

FIG. 4 shows a rear perspective view of the clamping mechanism of FIG. 3;

FIG. 5 shows a front view of the clamping mechanism of FIG. 4;

FIG. 6 shows a cross-sectional view taken through A-A of the clamping mechanism FIG. 5;

FIG. 7 shows a bottom perspective view of the clamping mechanism of FIG. 5;

FIG. 8 shows a cross-sectional view taken through B-B of the clamping mechanism of FIG. 5;

FIG. 9 shows a block diagram of a control system of the band saw of FIG. 1;

FIG. 10 shows a circuit diagram of a sensing system of the control system illustrated in FIG. 9;

FIG. 11 shows a circuit diagram of an emergency stop circuit of the control system of FIG. 9;

FIG. 12 shows a circuit diagram of a saw enable circuit of the control system of FIG. 9;

FIG. 13 is a front view of a further clamping mechanism embodied by the present invention in a primed state;

FIG. 14 is a front perspective view of the clamping mechanism of FIG. 13 following triggering of the clamping mechanism;

FIG. 15 is a rear perspective view of the clamping mechanism of FIG. 13;

FIG. 16 is a rear view of the clumping mechanism of FIG. 14.

FIG. 17 shows a block diagram of the control system of a further band saw embodied by the invention;

FIG. 18 shows a circuit diagram of a sensing circuit of the control system of FIG. 17;

FIG. 19 shows a circuit diagram of a further sensing circuit of the control system of FIG. 17; and

FIG. 20 shows a circuit diagram of an emergency stop circuit of the control system of FIG. 17.

### DETAILED DESCRIPTION OF PREFERRED EMBODIMENTS OF THE INVENTION

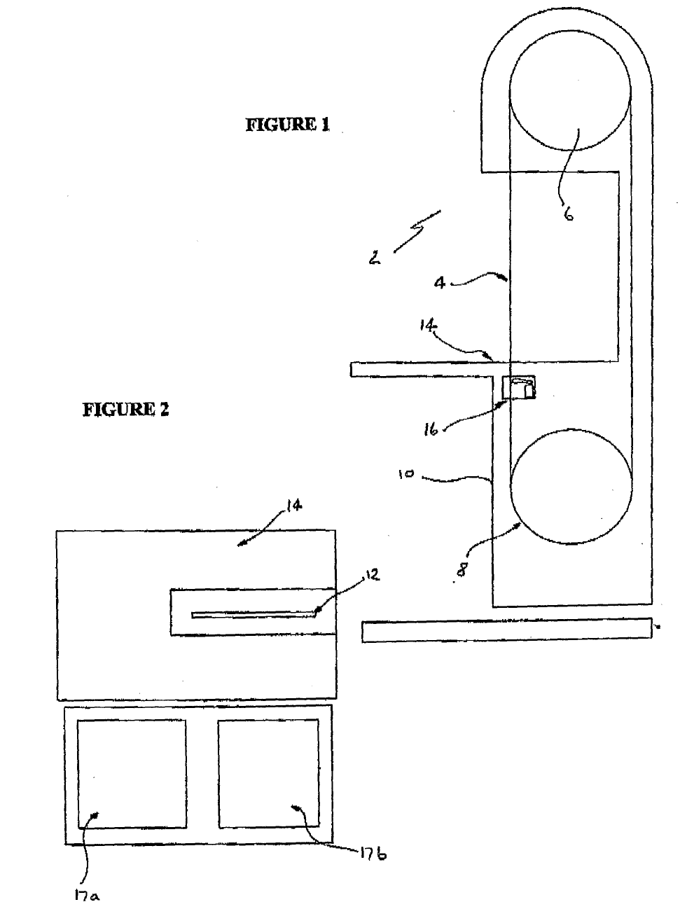

A band saw 2 used for cutting the carcass of an animal during processing of the carcass to provide cuts of red meat is shown in FIG. 1 which comprises an endless blade 4 driven around an upper pulley wheel 6 by a lower drive wheel 8. The drive wheel 8 in turn is driven by a motor (not shown) encased in housing 10 of the saw. The blade passes through a slit 12 in the cutting table 14 as indicated in FIG. 2. A clamping mechanism 16 through which the blade 4 passes is secured in position under the cutting table. As shown more clearly in FIG. 2, voltage applying means in the form of left and right stainless steel foot pads 17a and 17b are arranged in front of the saw. In use, an operator wearing conductive boots stands on the plates with one foot on each and a DC voltage is applied to the operator to induce flow of a low microamp electric current through the legs of the operator from plate to plate. The current that flows through the operator will typically be in a low microamp range.

A control system monitors for an electrical signal in the form of a current flow from the operator to the blade in the event of the operator making electrical contact with the blade during a cutting operation. Upon detection of flow of current to the blade by the control system, the clamping mechanism 16 is operated to clamp the blade to stop further travel of the blade about the upper pulley wheel 6 and lower drive wheel 8 and thereby minimise injury to the operator. The operator wears insulating gloves while handling the meat to prevent leakage of current to the blade and thereby inadvertent triggering of the clamping mechanism by the control system in the absence of contact of the operator with the blade during normal usage of the saw. As will be understood, electrical contact between the operator and the blade can occur by direct contact of the operator with the blade or for instance, via contact of conductive material (eg chain metal gloves worn by the operator) in electrical contact with flesh of the operator.

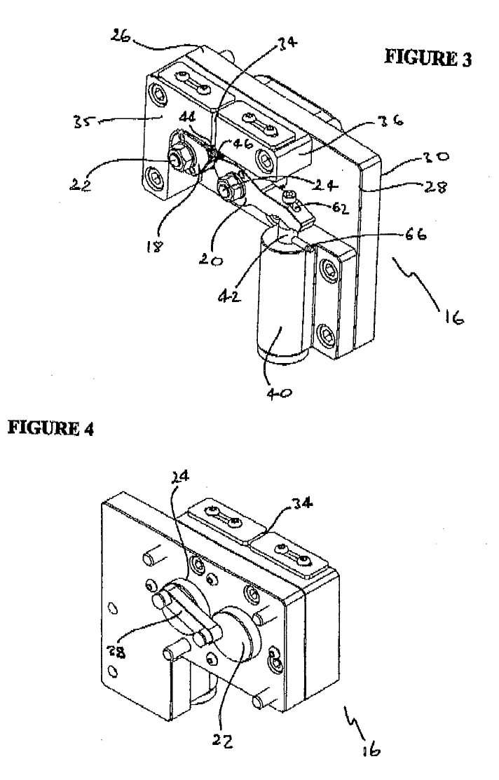

As shown in FIG. 3, the clamping mechanism comprises a pair of spaced apart clamping members 18 and 20 each of which is fixedly secured to respective spindles 22 and 24 that pass through mounting block 26 from the front side 28 of the mounting block to the rear side 30 thereof. The spindles are coupled together on the rear side of the mounting block 26 by a coupling clement 38 as shown in FIG. 4. The blade passes through slit 34 defined between guide blocks 35 and 36 of the mounting block 26 and between the clamping members 18 and 20.

Returning now to FIG. 3, the clamping mechanism 16 further comprises actuator means in the form of an actuator 40 and drive means in the form of a drive member 42. The drive member 42 is arranged to drive clamping member 20 counter-clockwise about its axis of rotation defined by spindle 24 when the drive member is driven upwardly with operation of the actuator 40 upon the control system of the band saw detecting flow of current from the operator to the blade of the saw.

As the drive member is driven upwardly forcing clamp member 20 and the spindle 24 to which it is secured to rotate counter-clockwise, clamping member 18 is driven in a clockwise direction under the action of the coupling clement 38 coupling clamp member 20 to spindle 22. The clamping members thereby rotate toward each other in unison and with continued travel of the drive member, are brought into contact with respective sides of the blade 4 such that the blade is gripped by the clamp members. The blade is initially moving in a downward direction and the travel of the blade further draws each of the clamping members downwardly resulting in the blade being clamped more tightly between the clamping members stopping the blade. In this condition, the clamping teeth on the protruding regions 44 and 46 of the clamping members are typically be forced into the blade a distance of approximately 0.2 mm below the surface of the respective sides of the blade.

In the arrangement shown in FIG. 3, the clamping members are arranged to clamp the blade in an opposed grip. In other embodiments, the clamping members may be arranged such that the protruding regions 44 and 46 of the clamping members are offset relative to one another when the blade is gripped. In this instance, the blade may be broken during the clamping action but remains gripped between the clamping members preventing further travel of the blade.

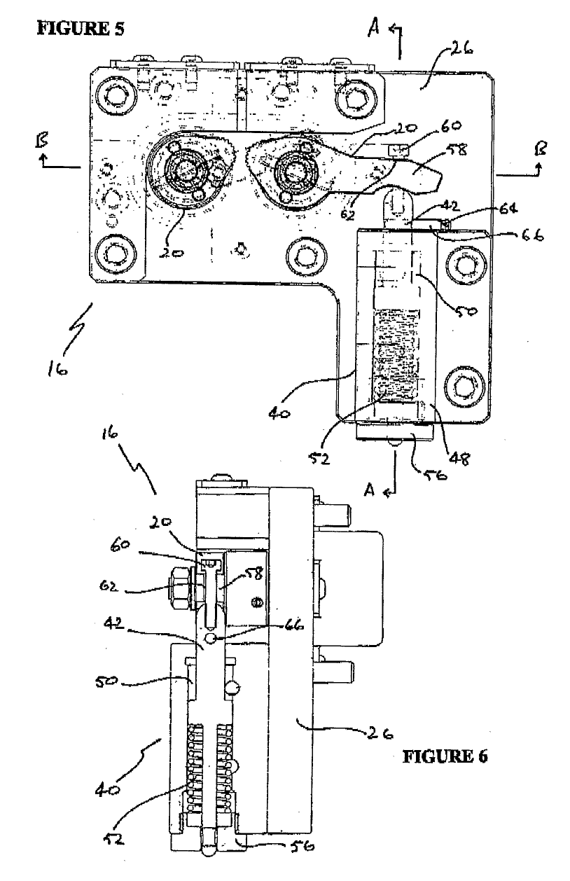

Turning now to FIG. 5 and FIG. 6, the actuator 40 further comprises a cylinder 48 secured in position on the mounting block 26. The cylinder 48 has an internal bore 50 in which is arranged biasing means in the form of a compression spring 52. The spring is held in a compressed working condition and is released upon the control system detecting flow of current to the blade of the band saw to drive the drive member 42 upwardly to effect the rotation of clamp members 18 and 20. A base cover 56 is threadably mated with the cylinder closing the base of the bore.

As can be seen, the drive member 42 projects from the cylinder and abuts the underside of finger 58 of clamping member 20. A bolt 60 passes through elongate aperture 62 of the clamping member 20 slidably coupling the drive member and the clamping member together.

The spring 52 receives the drive member 42 and is retained in the compressed working condition by restraining means in the form of a stainless steel fuse wire (not shown). The fuse wraps around groove 64 of pin 66 projecting from the drive member above the cylinder 48 of the actuator and the underside of an essentially non-conducting support in the form of a teflon block (not shown) to which the fuse is secured. The teflon block is mounted to the mounting block 26 alongside the actuator such that the fuse is under tension applied by the upward biasing force exerted by the spring 52. A pair of spaced apart raised conductors of the control system are provided on the underside of the Teflon block which are bridged by the fuse such that the fuse is in electrical contact with both conductors.

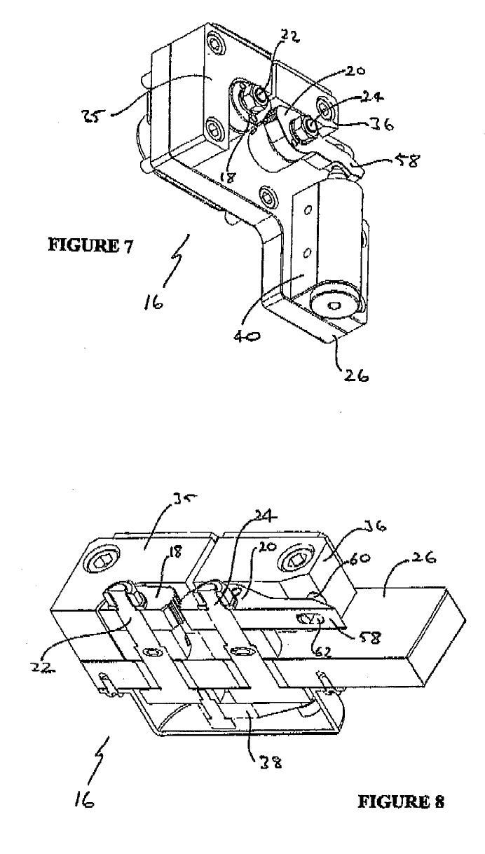

In the event the control system detects contact of the operator with the blade 41, a current is discharged through the fuse causing the fuse to blow. In the absence of the intact fuse, the spring 52 drives the drive member 42 upwardly against the clamping member 20 forcing the clamping member to rotate counter-clockwise to effect the clamping of the blade. The current discharged through the fuse wire is sufficient to blow the fuse within a few milliseconds. A bottom perspective view of the clamping mechanism is shown in FIG. 7 and a transverse cross-sectional view of the clamping mechanism is shown in FIG. 8.

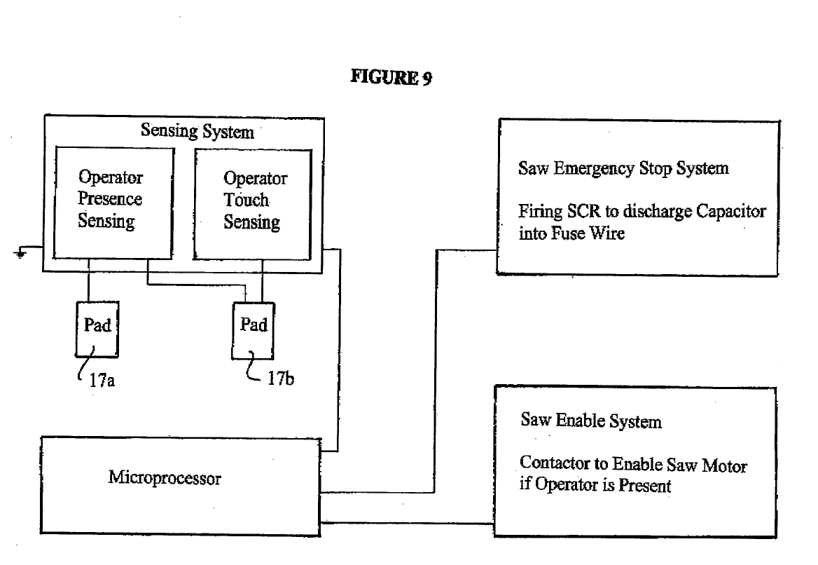

A block diagram of the control system of the band saw is shown in FIG. 9. The control system comprises a sensing system consisting of an operator presence sensing circuit for detecting the presence of the operator standing on the stainless steel foot pads 17a and 17b, and a touch sensing circuit for detecting contact of the operator if the insulating gloves worn by the operator are cut by the blade. A microprocessor monitors the sensing system and activates the saw emergency stop system to effect operation of the clamping mechanism if contact of the operator with the blade is sensed by the touch sensing system.

A saw enable circuit enables the saw for operation when the presence of the operator is detected by the operator sensing system and disables the hand saw in the event of triggering of the saw emergency stop system by the microprocessor or failure in the control system.

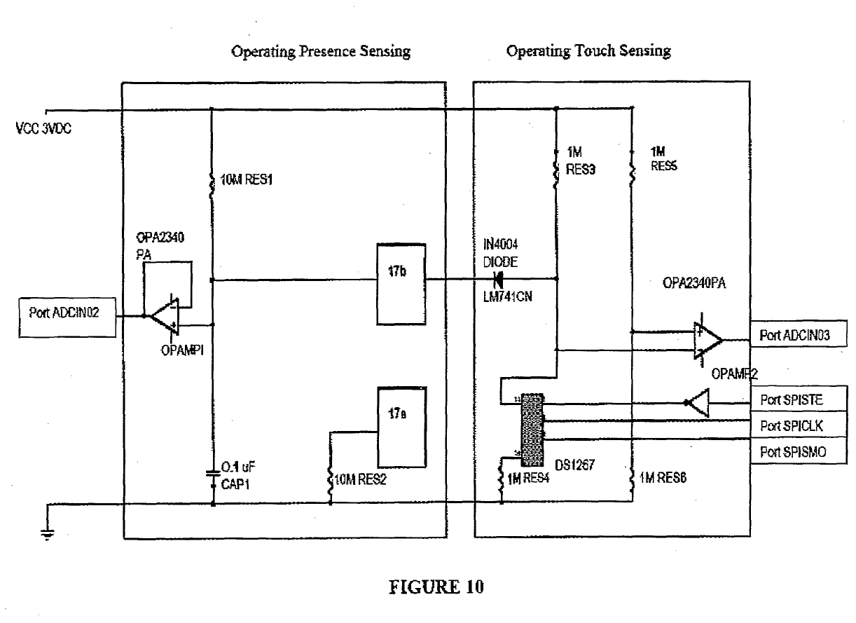

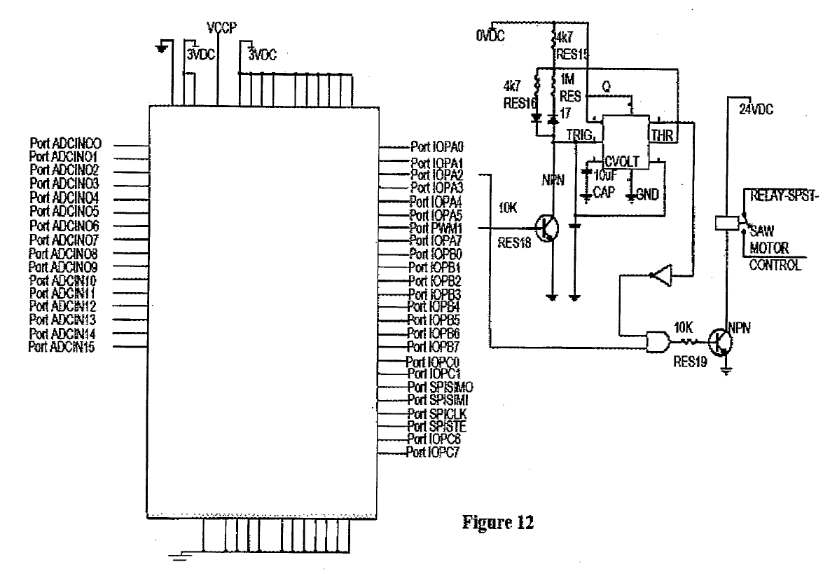

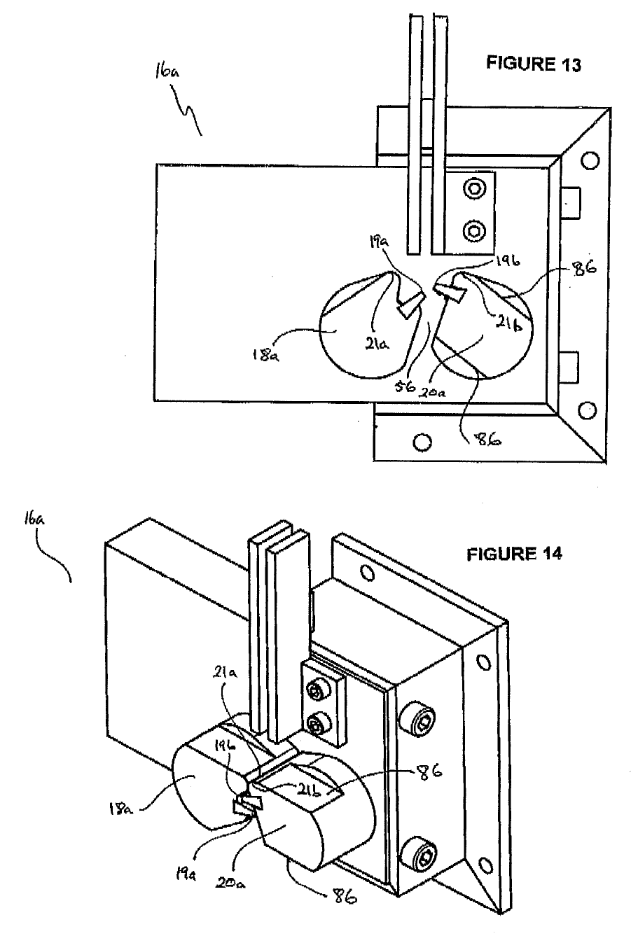

A preferred embodiment of the control system will now be described with reference to FIGS. 10 and 12. In the absence of the operator standing on the conductive stainless steel foot pads 17a and 17b the input to operational amplifier OP Amp 1 is at the supply voltage (see FIG. 10). Capacitor Cap1 is used to eliminate static input to OP Amp 1.

When the operator stands on the stainless steel foot pads 17a and 17b in conductive polymer boots, human resistance is introduced into the operator sensing circuit and a current flows through the operator from one leg of the operator to the other. A voltage divider is thereby established and the input to OP Amp 1 decreases from the supply voltage to a lower voltage dependant on the human resistance. OP Amp 1 is configured as a voltage follower and its high input incidence is used to isolate the voltage input to the microprocessor. Conductive boots made of suitable conductive polymer materials are commercially available. Socks or stockings will normally be worn by the operator as there is typically sufficient moisture present in socks when being worn for conduction of the current.

Rather than wearing boots made from a conductive polymer, the operator may be provided with boots with a conductive stud formed from a suitable metal that projects through the sole of each boot for contact with the corresponding stainless steel foot pad 17a or 17b. The stud may be welded or integrally formed with a metal plate which lies on the inner sole within the boot and on which the operator's foot rests. Alternatively, a retractable leash may be strapped to a leg of the operator for applying the voltage to the operator while the operator stands on a single conductive plate. Other alternatives of such voltage applying means are well within the scope of the skilled addressee.

In the present embodiment, the touch sensing circuit utilises two voltage dividers that feed to the differential inputs of operational amplifier OP Amp 2. The first voltage divider comprises resistor RES 3 and a programmable resistor. The resistance of the programmable resistor is determined by the microprocessor from the difference in input voltage to the microprocessor from the operator presence sensing circuit in the presence of the operator to thereby dynamically tune the touch sensing system to compensate for the electrical resistance introduced by the operator. In particular, the resistance of the programmable resistor is set by the microprocessor such that the voltage to the inverting input of OP Amp 2 is maintained just above the non-inverting input and thereby the output of OP Amp 2 low. The second voltage divider comprises resistors RES 5 and RES 6. In the event the operator contacts ground potential by the operator coming into electrical contact with the blade of the band saw, the resistance of the programmable resistor in parallel with the operator decreases. This lowers the voltage to the inverting input of OP Amp 2 below the voltage to the non-inverting input and causes the output of OP Amp 2 to go high. The high output of OP Amp 2 is detected by the microprocessor which activates the emergency stop system to operate the clamping mechanism 16 to clamp the blade 4. The microprocessor also effects disabling of the motor of the band saw by the saw enable system.

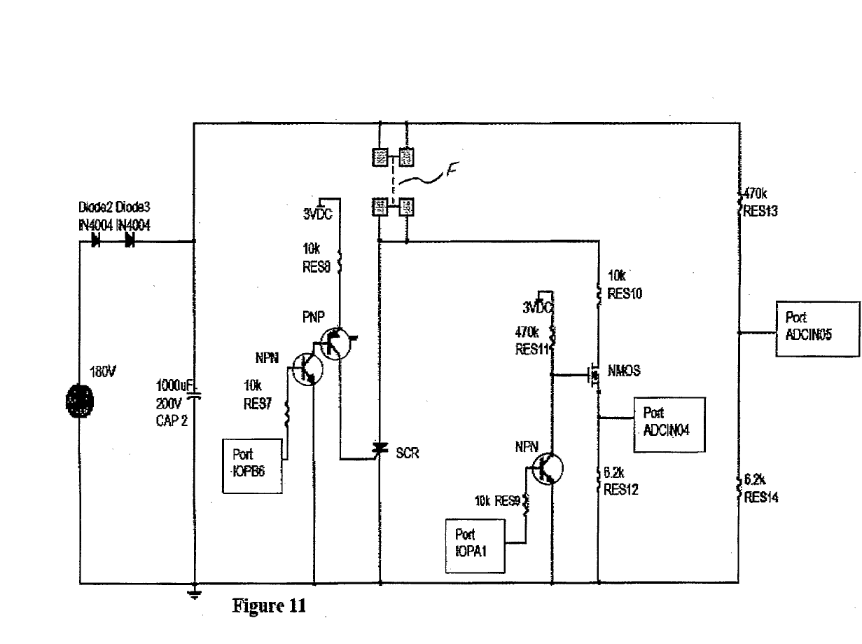

The emergency stop circuit is shown in FIG. 11 and comprises a 1000 μF capacitor CAP 2 which is charged by a 180V supply through diode 2 and diode 3. If contact of the operator with the saw blade is detected by the touch sensing circuit, the microprocessor triggers the SCR through the switch formed by the NPN and PNP transistors. This causes capacitor CAP 2 to discharge through the stainless steel fuse wire (F) restraining the spring 52 of the actuator 40 in the working condition, blowing the fuse and releasing the spring 52 to drive the clamping of the saw blade by the clamping members 18 and 20 of the clamping mechanism 16.

Resistors RES 13 and RES 14 of the emergency stop circuit create a voltage divider which is monitored by the microprocessor to check that capacitor CAP2 is in a charged state. A further voltage divider formed by resistors RES 11 and RES 12 is switched on periodically via the N MOSFET to confirm the fuse wire F is intact. In embodiments incorporating a high speed solenoid for controlling operation of the clamp members 18 and 20 as described below, the voltage divider confirms the coil of the solenoid is connected to the circuit and the correct resistance. If the emergency stop circuit fails to test correctly by the microprocessor, the saw motor is disabled from operation by the saw enable circuit.

The saw enable circuit Is shown in FIG. 12 and controls operation of a contactor C which enables or disables the saw motor in response to the microprocessor. The saw enable circuit further incorporates a timer circuit which monitors a pulse train from the microprocessor. The pulse train from the microprocessor is switched through an NPN transistor which resets the timer before the timer times out thereby preventing disabling of the hand saw motor via contactor (C). If the pulse train stops due to failure of the microprocessor, the timer circuit will disable the contactor (C) via the AND gate.

To further assist in ensuring the travel of the blade is stopped and to provide a back up to the clamping of the blade by the clamping mechanism 16, the control system may be configured to simultaneously operate a conventionally known electric brake to halt rotation of the armature of the band saw motor upon detection of contact by the operator with the blade 4 of the saw. Alternatively, for instance, a DC voltage may be applied to the motor in a conventionally known manner to halt rotation of the motor armature in combination with clamping of the blade of the saw as described herein.

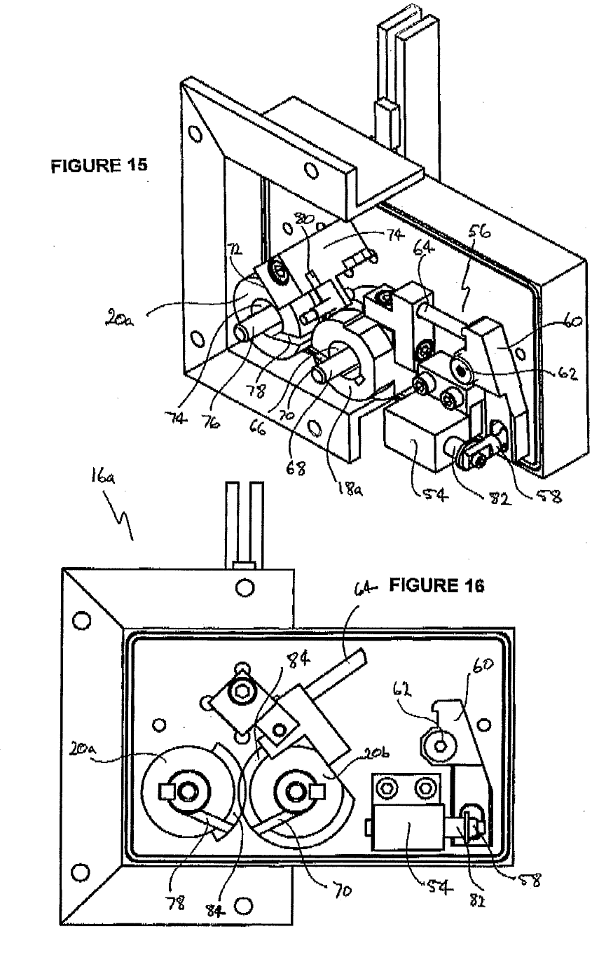

A further embodiment of a clamping mechanism 16a adapted for clamping the blade of a band saw is illustrated in FIG. 13. This embodiment comprises two counter-rotatable clamping members 18a and 20a as for the clamping mechanism illustrated in FIG. 3. However, the clamping members in this instance arc each respectively provided with a blade edge 19a, 19b and a clamping surface 21a, 21b. Moreover, in this embodiment the actuator means comprises a solenoid 54 coupled to restraining means in the form of a latch for controlling the rotation of the clamping members to clamp the blade as described in relation to FIGS. 15 and 16.

As can be seen, the clamping members are arranged in a side by side relationship and receive the blade of the band saw in the space 56 therebetween when the clamping members are held in the primed position by the restraining means as shown in FIG. 13. In the event the control system detects electrical contact between the operator and the blade, a current is discharged through the solenoid coil causing the solenoid to disengage the latch. This permits the clamping members to counter-rotate toward each other about their respective axis of rotation under the action of drive means provided by spring means as further described below. As the clamping members rotate, the blade 4 of the band saw is sheared by the co-operating blade edges 19a and 19b of the clamping members in a scissor action from the front edge of the blade through to the rear edge of the blade, and clamped between the clamping surfaces 21a, 21b of the clamping members. The current discharged through the solenoid coil is again sufficient to effect clamping of the blade within a few milliseconds. The position of the clamping members relative to one another following clamping of the blade is shown in FIG. 14.

As illustrated more clearly in the rear view of the clamping mechanism in FIG. 15, the solenoid 54 is coupled to the latch 56 by a link arm 58. The latch comprises a trigger 60 pivotable about pivot point 62, and a clasp 64 fixedly mounted on clamping member 18a for rotation with the clamping member. The counter-rotation of the clamping members is effected by spring means arranged to drive the clamping members about their respective axis of rotation upon release of the clasp 64 by the trigger 60 of the latch.

The spring means comprises a first spiral torsion spring (not shown) received in the recess 66 of rear element 67 of clamping member 18a about spindle 68 of the clamping member. One end of the spring is received in slot 70 defined in the rear clement and an opposite end of the spring is received in a slot indicated by the numeral 72 defined in fixed post member 74. A second torsion spring (not shown) of the spring means is received in the recess 74 of rear clement 75 of the clamping member 20a about spindle 76 of the clamping member. One end of this spring is received in slot 78 provided in rear element 75 and the other end of the spring is received in slot 80 of the post member 74.

When operated by the control system of the band saw in the event of an operator contacting the blade of the saw, the plunger 82 of the solenoid is drawn into the solenoid operating link arm 58 to pivot trigger 60 about pivot point 62 via an internal coupling mechanism of the latch (not shown). With rotation of the trigger about pivot point 62, the clasp 64 of the latch is released. This permits the clumping members to counter-rotate under the action of the spring means to shear and clamp the blade, whereby the clamping members and the clasp are rotated to the positions in FIG. 16. As further indicated in FIG. 16, the clamping members 18a and 20a are provided with intermeshing teeth 84 around peripheral regions of the clamping members such that rotation of one of the clamping members further drives rotation of the other of the clamping members.

As also indicated in FIGS. 13 and 14, recesses arc defined on opposite peripheral sides of clamping member 20a defining opposing surfaces 86 for permitting engagement of a tool such as a spanner or the like with that clamping member for rotation of the clamping member back to its primed position to reset the clamping mechanism.

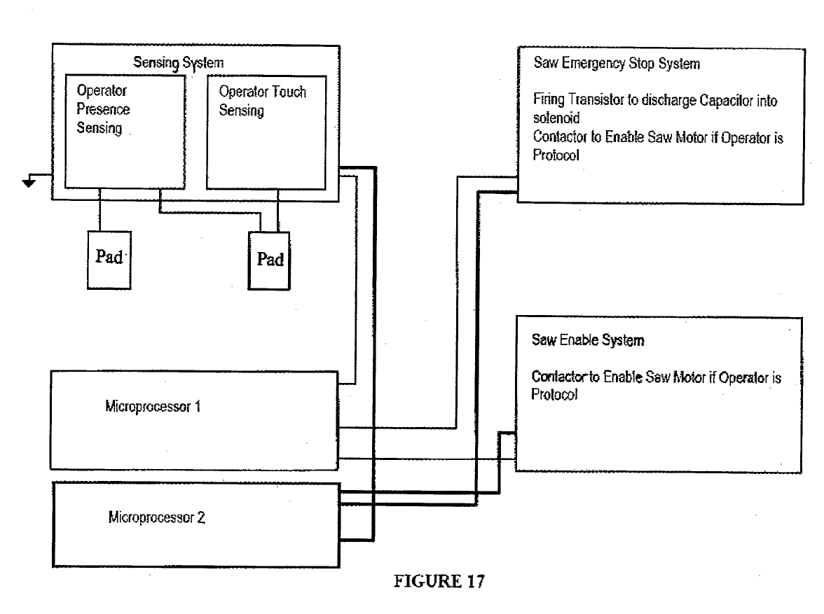

An embodiment of an operator protection system of the invention incorporating the solenoid clamping mechanism 16a illustrated in FIG. 13 will now be described with reference to FIGS. 17 to 20. A block diagram of the control system of this embodiment is shown in FIG. 17. In this embodiment, voltage applying means in the form of an arm strap (in this case a wrist strap) incorporating two stainless steel conductive pads 17a and 17b electrically connected to the control system of the band saw is worn by the operator. A pulsed −5V DC signal is applied to the operator via the arm strap to induce flow of a low microamp electric current across the arm of the operator from one of the conductive pads of the arm strap to the other. Another arm strap is also provided for application of the pulsed −5V DC signal to a further operator in the same manner during training demonstrations of the operation of the band saw or when two operators are required for processing larger cuts of meat. The band saw will not operate if an arm strap is not attached to the body of an operator.

Briefly, the control system of this embodiment comprises a dual microprocessor system with redundant circuits for all sensing inputs. In this system, a 24V DC signal is applied to the band saw including to the blade of the saw. In the event of an operator coming into electrical contact with the blade or an exposed conductive portion of the band saw, the control system detects flow of a microamp current from the saw to the arm strap attached to the operator. Upon detection of the current, the control system supplies a 68V DC signal to the solenoid coil of the clamping mechanism 16a to effect shearing and clamping of the blade as described above.

As with the embodiment of the control system illustrated in FIG. 9, the operator wears electrically insulated gloves to prevent false trigger of the clamping mechanism 16a during normal operation or the band saw. The dual microprocessors utilized in this embodiment ensure the control system will still function to disable the saw in the unlikely event of one of the processors failing. The microprocessors are configured to communicate with each other to establish each others operational status and should they not correspond correctly, the band saw is disabled from operation. The control system of this embodiment also monitors mechanical response time and should this time be out of specification, disables the band saw.

To use this embodiment of the band saw, the operator must initially perform a number of control system check steps. Firstly, the control system requires the operator to test the stop button in response to a Power On Reset request on a liquid crystal display (LCD) of a control panel of the saw. Once the operator has performed this step, the operator is prompted to attach the arm strap in response to a request displayed on the LCD. Prior to permitting operation of the band saw, the control system subsequently requires a touch test of the blade of the saw by the operator to ensure the touch sensing circuitry of the control system is functioning properly. Only once these tests have been completed and proper functioning determined will the control system permit operation of the saw using via the start and stop buttons on the control panel of the saw.

If the operator removes the arm strap during operation of the band saw, the saw is disabled by the control system which will only permit the band saw to be restarted once the arm strap is re-attached and another series of control system check steps as described above are performed by the operator. If any faults are detected in the control system, a message is displayed on the LCD indicating the fault and step(s) necessary to correct the fault. During any fault status, operation of the band saw is again disabled by the control system.

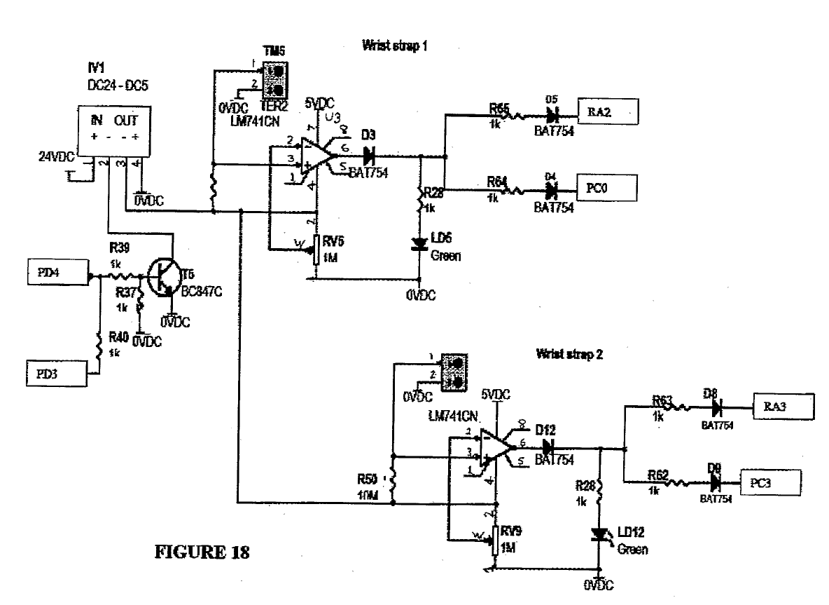

In the absence of the operator wearing the arm strap the positive input to operational amplifier OP Amp 1 of the control system is at the negative supply voltage (see FIG. 18). When the operator wears the arm strap, human resistance is introduced into the operator sensing circuit of the control system and a current flows between conductive pads 17a and 17b across the operator's arm. A voltage divider is thereby established and the input to OP Amp 1 decreases from the supply voltage to a lower voltage dependant on the human resistance. OP Amp 1 is configured as a comparator and its high input impedence is used to isolate the voltage input to the microprocessor. It also compares the voltage formed by the divider to a setpoint adjusted with RV1.

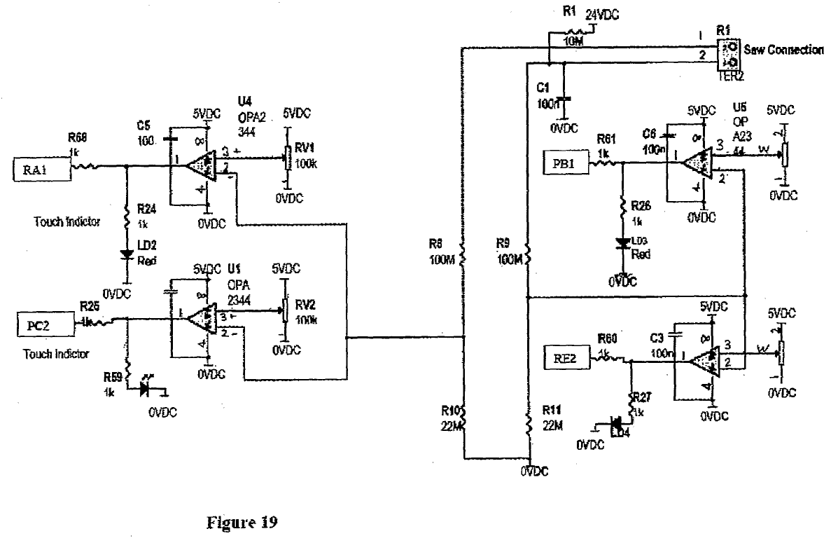

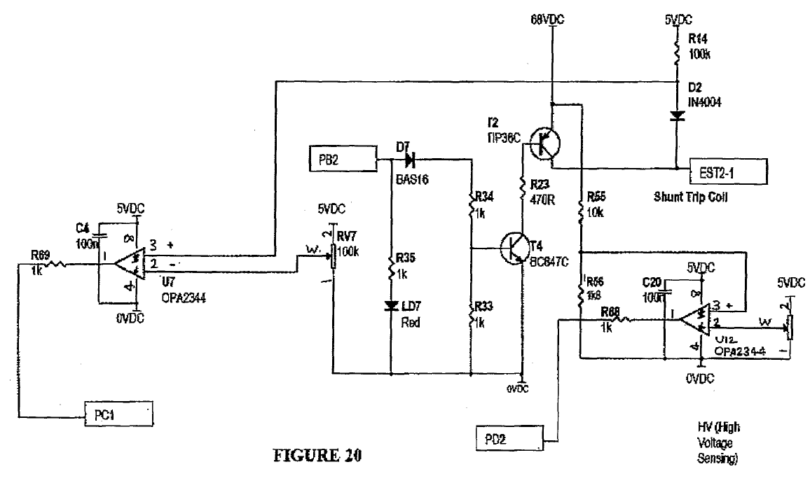

The touch sensing circuit shown in FIG. 19 utilises two voltage dividers that feed to the negative inputs of operational amplifiers 2, 3, 4 and 5. With the saw connected, 24V DC is applied via R1 to the top of the voltage dividers. If the saw connection is broken, only one voltage divider will be powered and the operation of the saw will be disabled. A capacitor is used to reduce noise on the sensing circuit.

The high output of OP Amp 2 or 5 is detected by a microprocessor which activates the emergency slop system to operate the clamping mechanism 16 to clamp the blade 4. The microprocessor also effects disabling of the motor of the band saw by the saw enable system. Similarly, Op Amps 3 and 4 connect to the secondary microprocessor to activate a secondary emergency stop trigger and motor disabling.

The emergency stop circuit shown in FIG. 20 comprises a 10,000 μF capacitor CAP 1 which is charged by the 68V DC supply. If electrical contact of the operator with the saw blade is detected by the touch sensing circuit, the microprocessor triggers the touch sensing circuit and more particularly, the PNP transistor through the switch formed by the NPN transistor. This causes capacitor CAP 1 to discharge through the solenoid coil of the solenoid of the clamping mechanism 16a, actuating the solenoid and disengaging the latch 56 permitting the spring means to drive the shearing and clamping of the saw blade by the clamping members 18a and 20a of the clamping mechanism.

Resistors in the emergency slop circuit create a voltage divider which is monitored to check that capacitor CAP1 is in a charged state. A further Op amp comparator monitors the state of the solenoid coil, and is isolated from the 68V DC supply in the event of an emergency stop. If the emergency stop circuit fails to test correctly, the saw motor is disabled from operation by the saw enable circuit.

A saw enable circuit of this embodiment controls operation of a contactor C which enables or disables the saw motor. The saw enable circuit further incorporates a watchdog timer that monitors the operation of the program running in a microcontroller. If the watchdog timer is not reset due to failure of the microprocessor, the microcontroller will be reset disabling the contactor (C) via a solid state relay.

As will be understood, the electrical signal detected by the control system of the band saw may be any signal or voltage waveform suitable for detection to effect clamping of the blade as described herein. The provision of circuits for the provision of signals other than those described herein is well within the scope of the skilled addressee. Moreover, arrangements may be provided wherein only a single one of the clamping members is provided with a blade for shearing the blade in cooperation with the other of the clamping members.

It will be understood by persons skilled in the art that numerous variations and/or modifications may be made to the invention without departing from the spirit or scope of the invention as broadly described. For example, the skilled addressee would be able to readily modify the control system yet still obtain clamping of the blade of the saw. The present embodiments are, therefore, to be considered in all respects as illustrative and not restrictive.

1. An operator protection system for protecting an operator of an electrically powered saw from the blade of the saw during a cutting operation, the saw being of the type including a cutting table through which the blade passes, and the protection system comprising:
clamping means for clamping the blade to stop travel of the blade;
control system means conductively connected to the blade and adapted to monitor for conduction of an electrical signal between the operator and the blade in event of electrical contact of the operator with the blade; and
actuator means operable by the control system means to operate the clamping means to clamp the blade upon detection of the conduction of the electrical signal by the control system means.

2. A system according to claim 1 wherein the control system means comprises:
a touch sensing circuit for sensing contact of the operator with the blade during the cutting operation; and
an emergency stop circuit for triggering the actuator means to operate the clamping means to clamp the blade and which is responsive to the touch sensing circuit.

3. A system according to claim 2 wherein the touch sensing circuit is adapted to compensate for electrical resistance of the operator for sensing the contact with the blade.

4. A system according to claim 1, wherein the saw comprises a saw motor for driving the blade and the control system further comprises an operator sensing circuit for sensing presence of the operator, the control circuit being configured to allow operation of the saw motor only when the presence of the operator is sensed.

5. A system according to claim 4 further comprising voltage applying means for applying a voltage to the operator for the sensing of the presence of the operator by the operator sensing circuit.

6. A system according to claim 5 wherein the signal is generated by the voltage applied to the operator.

7. A system according to claim 6 wherein the signal is a current signal induced in the operator by the voltage.

8. A system according to claim 4 wherein the control system is configured for conductively applying a voltage to the blade for generation of the signal.

9-15. (canceled)

16. An electrically powered saw adapted to protect an operator from the blade of the saw during a cutting operation, the saw being of the type incorporating a cutting table through which the blade passes, and comprising:
clamping means for clamping the blade to stop travel of the blade;
control system means conductively connected to the blade and adapted to monitor for conduction of an electrical signal between the operator and the blade in event of electrical contact of the operator with the blade; and
actuator means operable by the control system means and arranged to operate the clamping means to clamp the blade upon detection of the conduction of the electrical signal by the control system means.

17. A saw according to claim 16 wherein the saw is a band saw.

18. A control system for protecting an operator from the blade of an electrically powered saw during a cutting operation utilizing the saw, the saw being of the type comprising a cutting table through which the blade passes, and the control system comprising:
a touch sensing circuit for sensing conduction of an electrical signal between the operator and the blade in event of electrical contact of the operator with the blade;
an emergency stop circuit for triggering operation of clamping means to clamp the blade to stop travel of the blade, the emergency stop circuit being responsive to the touch sensing circuit, and the touch sensing circuit is configured for being conductively connected with the blade.

19-34. (canceled)

35. A clamping mechanism suitable for being fitted to an electrically powered saw of the type incorporating a cutting table through which the blade of the saw passes and to stop travel of the blade in event of an operator coming into contact with the blade during a cutting operation, the clamping mechanism comprising:
clamping means adapted to break or shear the blade during the clamping of the blade; and
actuator means for effecting operation of the clamping means to clamp the blade, the actuator means being operable by a control system for detecting the contact of the operator with the blade.

36. A clamping mechanism according to claim 35 wherein the saw is a band saw.

37. A method for protecting an operator of an electrically powered saw from the blade of the saw during a cutting operation, the saw being of the type incorporating a cutting table through which the blade passes, and the method comprising:
providing clamping means for clamping the blade to stop travel of the blade;
insulating the operator against electrical contact with the blade, the band saw having control system means for monitoring for conduction of an electrical signal between the control system means and the blade in event of the operator coming into electrical contact with the blade; and
monitoring for conduction of the electrical signal using the control system means, the clamping means being operable to clamp the blade upon detection of the conduction of the electrical signal by the control system means and the control system means being conductively connected to the blade.

38-47. (canceled)

48. A system according to claim 1 wherein the clamping means is adapted to break or shear the blade during the clamping of the blade.
